(19) United States
(12) Patent Application Publication
(10) Pub. No.: US 2014/0359790 A1
(43) Pub. Date: Dec. 4, 2014

(54) METHOD AND APPARATUS FOR VISITING PRIVACY CONTENT

(71) Applicant: TENCENT TECHNOLOGY (SHENZHEN) COMPANY LIMITED, Shenzhen (CN)

(72) Inventors: Ye Zou, Shenzhen (CN); Rulan Lin, Shenzhen (CN)

(21) Appl. No.: 14/325,700

(22) Filed: Jul. 8, 2014

Related U.S. Application Data
(63) Continuation of application No. PCT/CN2013/088892, filed on Dec. 9, 2013.

(30) Foreign Application Priority Data
Jun. 3, 2013 (CN) 201310216550.2

(51) Int. Cl. G06F 21/62; G06F 21/31

(52) U.S. Cl. CPC G06F 21/6218; G06F 21/31
USPC 726/28; 726/26

(57) ABSTRACT

Described is a method, apparatus for visiting privacy content. The method includes: obtaining system input event, and extracting input data corresponding to the system input event; obtaining sample data matching with the input data; accessing to an application corresponding to the sample data; and displaying privacy content of the application. The method and the apparatus for visiting privacy content is used to reduce user operating steps and improve operating efficiency.

### CROSS-REFERENCE TO RELATED APPLICATIONS

The present application is a continuation application of International Application No. PCT/CN2013/088892, filed Dec. 9, 2013, which claims the priority to Chinese application No. 201310216550.2 filed Jun. 3, 2013, which are incorporated herein by reference in their entireties.

### FIELD OF THE INVENTION

The present disclosure relates generally to mobile Internet technology, and more particularly to a method, apparatus for visiting privacy content.

### BACKGROUND OF THE INVENTION

Traditional operating system of a smart phone generally supports privacy content protection. In one way, applications of the smart phone are provided with hidden folders for storing users' private data. Users need to enter appropriate password before accessing to the hidden folder. For example, a photo application generally includes a private album, and the private album stores privacy photos. In order to access to the private album and visit the private photos, the users need to enter a password. For another example, SMS (Short Message Service) generally includes privacy messages. To visit the privacy messages, the users also need to enter a password.

If users want to visit the privacy content of an application, they need to access to (or log in) the application firstly, click on buttons of visiting privacy content, and then enter the password in a Password Pop-Up Box. Verification is needed before visiting the privacy content. To sum up, such an operation procedure is relatively complex, and therefore convenience of the operation procedure is insufficient.

Therefore, heretofore unaddressed needs exist in the art to address the aforementioned deficiencies and inadequacies.

### SUMMARY OF THE INVENTION

In one aspect, the present disclosure relates to a method for visiting privacy content which can improve the convenience of the operation procedure.

In one embodiment, a method for visiting privacy content includes:

obtaining system input event, and extracting input data corresponding to the system's input event;

obtaining sample data matching with the input data;

accessing to an application corresponding to the sample data; and

displaying privacy content of the application.

In another aspect, the present disclosure relates to an apparatus for visiting privacy content which can improve the convenience of the operation procedure.

In one embodiment, the apparatus includes:

event monitoring module, configured to obtain system input event, and extract input data corresponding to the system input event;

sample obtaining module, configured to obtain sample data matching with the input data;

application positioning module, configured to access to an application corresponding to the sample data; and

content display module, configured to display privacy content of the application.

In yet another aspect of the present disclosure, the apparatus includes:

memory;

one or more processors; and

one or more modules stored in the memory and configured to execute by the one or more processors, the one or more modules including instructions:

to obtain system input event, and to extract input data corresponding to the system input event;

to obtain sample data matching with the input data;

to access to an application corresponding to the sample data; and

to display privacy content of the application.

As can be seen from the above technical solutions, according to the embodiments of the present disclosure, the above method and apparatus for visiting privacy content is used to reduce user operating steps and improve operating efficiency, by obtaining system input event, and further obtaining the corresponding application by matching it with the input data extracted from the system input event. In this case, the user can access to the privacy content, free of accessing to the corresponding application.

These and other aspects of the present disclosure will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is a flowchart of a method for visiting privacy content according to one embodiment of the present disclosure.

FIG. 2 is an operating interface of mobile phone according to another embodiment of the present disclosure.

FIG. 3 is an operating interface of mobile phone according to yet another embodiment of the present disclosure.

FIG. 4 is an operating interface of mobile phone according to a further embodiment of the present disclosure.

FIG. 5 is an operating interface of mobile phone according to yet a further embodiment of the present disclosure.

FIG. 6 is a block diagram of an apparatus for visiting privacy content according to one embodiment of the present disclosure.

FIG. 7 is a block diagram of an apparatus for visiting privacy content according to another embodiment of the present disclosure.

FIG. 8 is a block diagram of an apparatus for visiting privacy content according to yet another embodiment of the present disclosure.

### DESCRIPTION OF THE PREFERRED EMBODIMENTS

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are configured to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more operations within a method is executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules is executed using a single (shared) processor. In addition, some or all code from multiple modules is stored by a single (shared) memory. The term “group”, as used herein, means that some or all code from a single module is executed using a group of processors. In addition, some or all code from a single module is stored using a group of memories.

The systems and methods described herein are implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

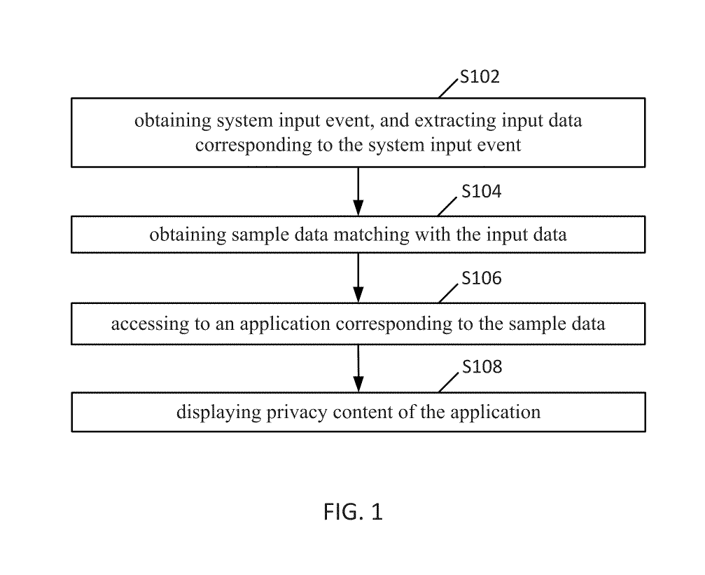

In embodiments of the present disclosure, as shown in FIG. 1, a method for visiting privacy content is provided. The method is totally based on computer program, and the computer program can be run on, but not limited to, mobile devices based on Von Neumann architecture. The mobile devices can be smart phones, tablet PCs, laptop computers, handheld computers and electronic readers. The method includes a number of steps of:

Step S102: obtaining system input event, and extracting input data corresponding to the system input event.

In this embodiment, the system input event can be, for example, input event captured by system event monitor of the smart phone operating system. The system input event is generally generated by a driver of an input device of the smart phone, and is captured by the operating system of the smart phone.

In one embodiment, the system input event is selected from the group consisting of a (UI) sliding gesture input event, a voice input event, a key trigger event and an event triggered by an acceleration sensor.

The (UI) sliding gesture input event is generally referred to as a system input event generated by sliding (by a finger or a stylus) on a touch screen of the smart phone along a certain path. The system input event is generated by the driver of the touch screen. An input data of the sliding gesture input event is generally in the form of the sliding path (e.g., a series of coordinates along touch points), i.e., a clockwise and circular sliding path, a horizontal path toward a right side.

The voice input event is generally referred to as a system input event generated by inputting voice data through microphones of the smart phones, the voice input event is generated by the driver of the microphone. An input data of the voice input event is generally in the form of an audio clip, i.e., a “Open Sesame” voice clip.

Specific key triggering event is generally referred to as a system input event generated by a keypad (or a keyboard, which, for example, can be a physical keyboard or a virtual keyboard) of the smart phone. The system input event is generated by the driver of the keyboard. An input data of the specific key input data is generally in the form of a sequence of key identifications, that is, a sequence of key identifications typed in sequence, such as a sequence of keys A, B, C, D typed (in sequence).

Acceleration sensor triggering event is generally referred to as a system input event generated by shaking the smart phone. The system input event is generated by the driver of the acceleration sensor. An input data of the acceleration sensor triggering event is generally in the form of a frequency and an amplitude of shaking

Step S104, obtaining sample data matching with the input data.

Step S106, accessing to an application corresponding to the sample data.

In this embodiment, sample data is reference data corresponding to the application and is generally, previously set. For example, the sample data can be pre-set for the application. When the input data matches with the sample data, a request is sent to visit privacy content of the application corresponding to the sample data. The applications can be native contact applications embedded in the operating system of the smart phone, short message applications or album applications, or can be third-party applications such as document management applications, diary applications.

In one embodiment, the input sample data can be obtained; and then an application can be selected; and sequentially a binding relationship between the sample data and the selected application can be stored.

In one usage scenario, a guide interface is provided to binding the sample data with the application. Users can slide on the touch screen to form a sliding path, such as a clockwise and circular sliding path, then an application list is displayed. Once the user selects an application in the list, a binding relationship between the clockwise and circular sliding path and the selected application can be stored. As such, a relationship between the clockwise and circular sliding path and the selected application is established. In this embodiment, the input sliding path is the sample data corresponding to the selected application.

In use, the user inputs the clockwise and circular sliding path on a desktop state of the smart phone, then the input data extracted from the system input event is the clockwise and circular sliding path, which matches with the stored sample data. In this way, the application can be found by recognizing the relationship of the sample data and the application.

In this embodiment, to determine whether the input data matches with the sample data, a characteristic value of the input data can be firstly calculated. The characteristic value is used to determine whether the input data matches with the sample data.

For example, the input event corresponding to the sliding path can be converted into a sign language. If the input data is the same as the sample data, then the input data matches with the sign language of the sample data. For voice data of the voice input event, text string of the voice data can be obtained by speech recognition. If the input speech data is the same with the text string of the sample data, then the input speech data matches with the sample data.

It should be noted that the above method for determining whether the input data matches with the sample data can be realized by using existing library functions.

Step S108, displaying privacy content of the application.

In this embodiment, the privacy content of the application is displayed after accessing to a privacy folder of the application. In this way, data of the privacy folder can be obtained and displayed.

In one embodiment, a password input interface can be displayed before displaying privacy content of the application. In this way, the input password can be verified. If the verification process is passed, then the privacy content of the application is displayed.

The input password can be a gesture password, a voice password or a string password. In other words, the user can trigger system input event by operating on the desktop of the smart phone, thus to access to the application. In addition, the user can access to the application's private folders by entering password in the pop-up input box of the application. To sum up, password verification process should be passed twice before accessing to the private folders, to prevent users from carelessly opening (or login) the privacy content, thereby increasing security of the privacy content.

In one embodiment, after extracting input data of the system input even, the method further includes: obtaining focus object, and obtaining a focused application corresponding to the focus object; obtaining sample data of the focused application, determining whether the input data matches with the sample data of the focused application, and if the input data matches with the sample data of the focused application, then the privacy contents of the focused application is displayed.

In this embodiment, the focused applications refers to a currently active application, and the focus objects refer to components of the currently active application, such as the application's main window, etc. For example, if the user triggers the system input event when a certain application operating in the smart phone's main interface rather than in the smart phone's desktop state, then the sample data of the focused application is obtained in priority. In this embodiment, this step further comprises determining whether the sample data matches with the input data of the triggered system input event, and if the sample data matches with the input data of the triggered system input event, the application shows the its privacy content.

Furthermore, if the sample data does not match with input data of the triggered system input event, then searching the sample data matching with the input data in the stored sample data. If the sample data matching with the input data is searched, further obtain the corresponding application of the sample data, and display privacy content of the application. If the sample data matching with the input data is not searched, then pass the system input event to other event processing module.

In this embodiment, a priority of matching the focus object can save time for searching the sample data, thereby increasing efficiency. It should be noted that, before displaying privacy content of the focus object, a password input interface guide can be displayed, thus double verifications are introduced to improve security of the privacy content.

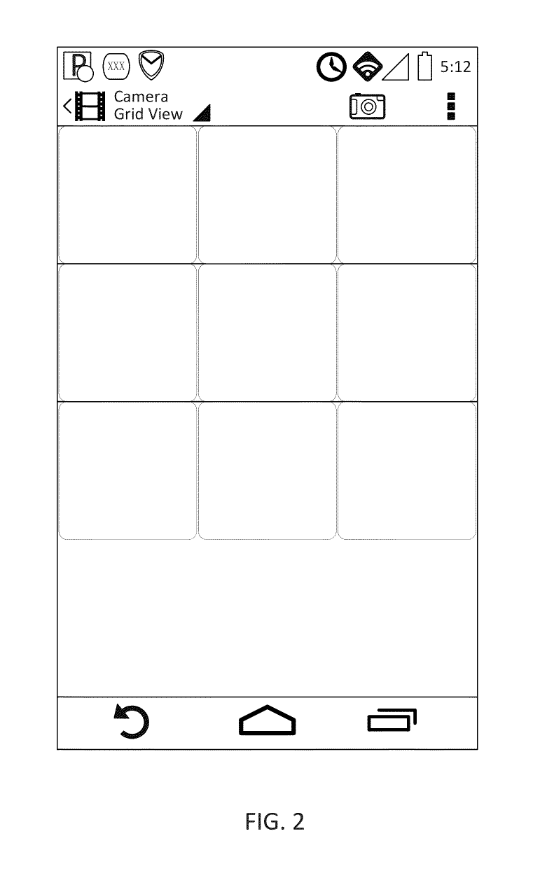

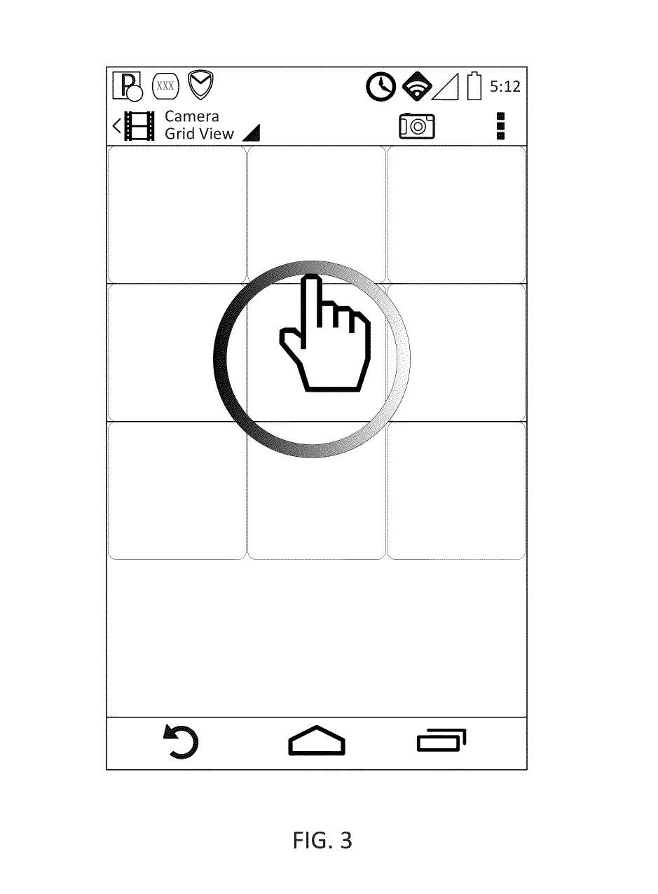

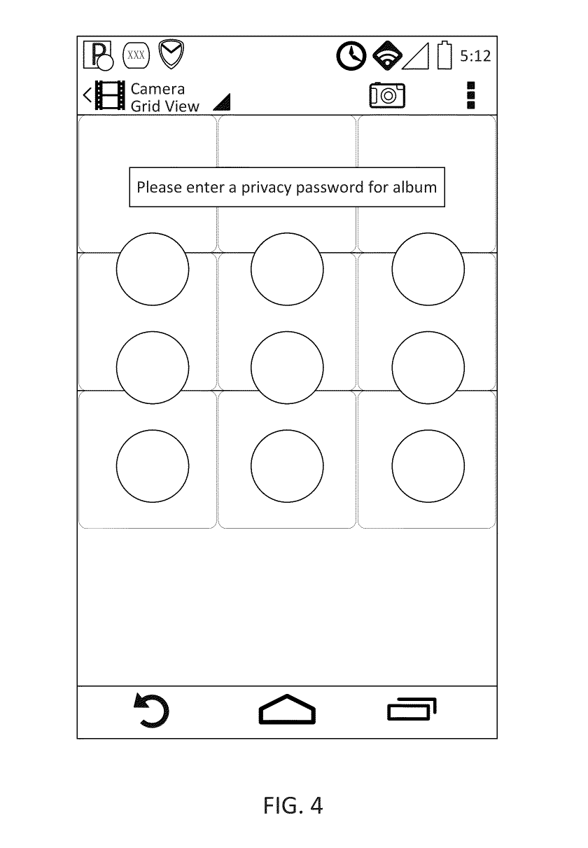

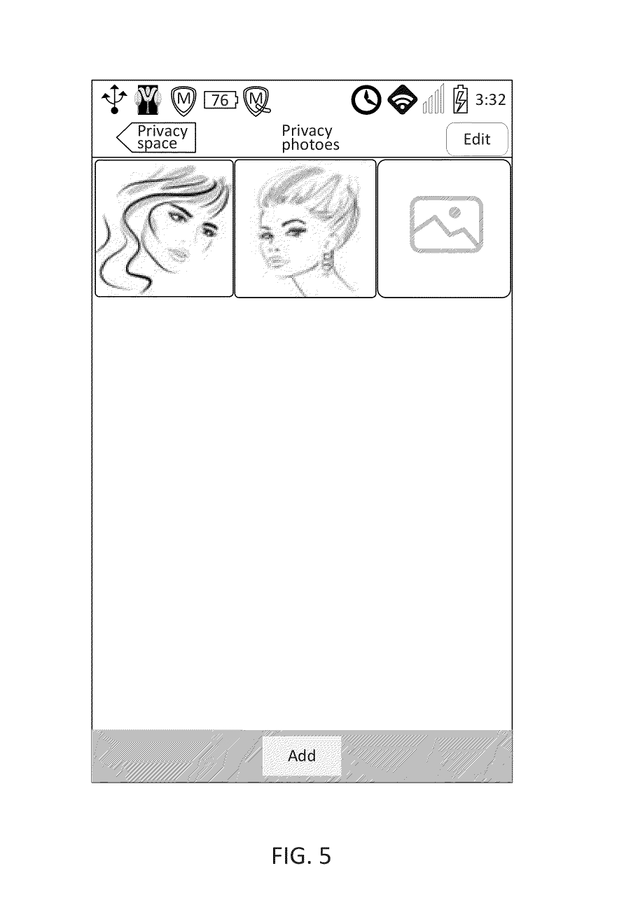

For example, in one scenario as shown in FIG. 2, the user picks up a mobile phone and accesses to the album application, in such case the album application is activated, that is, the photo album is a focused application. As shown in FIG. 3, the user can slide a clockwise and circumferential path on the touch screen, and once the clockwise and circumferential path matches with sample data of the photo album, then a password entry interface is shown (see FIG. 4). In this embodiment, the password input interface is designed to be verified by gesture language, and the user can slide to unlock the password verification. Validation is passed as shown in FIG. 5, and privacy photos stored in a private album of the album application are displayed.

In this embodiment, if the sliding path does not match with sample data of the album, then searching for the sample data matching with the clockwise and circumferential sliding path. If the matched sample data of the corresponding application is a SMS application, then a privacy content of the SMS application is, according show.

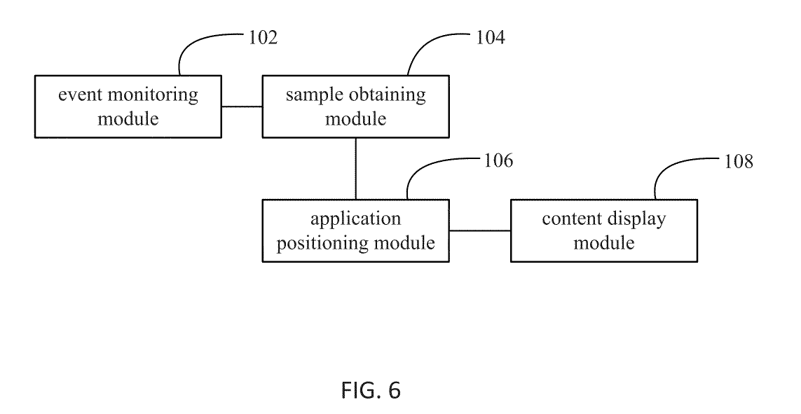

In one embodiment, as shown in FIG. 6, an apparatus for visiting privacy content includes an event monitoring module 102, a sample obtaining module 104, an application positioning module 106, and a content display module 108.

In this embodiment, the event monitoring module 102 is used to obtain system input event, and extract input data corresponding to the system input event.

The sample obtaining module 104 is used to obtain sample data matching with the input data.

The application positioning module 106 is used to access to an application corresponding to the sample data.

The content display module 108 used to display privacy content of the application.

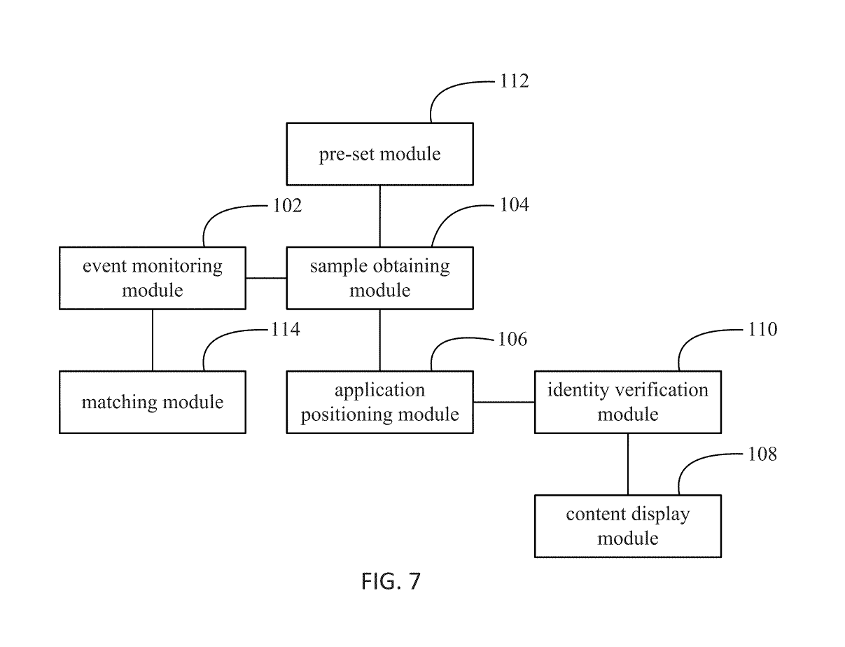

In one embodiment, as shown in FIG. 7, the apparatus further includes an identity verification module 110. The identity verification module 110 is used to display a password input interface before displaying privacy content of the application. In this way, the input password can be verified. If the verification process is passed, then the content display module 108 can be introduced (or activated) to display the privacy content of the application.

In one embodiment, as shown in FIG. 7, the apparatus further includes a pre-set module 112, the pre-set module 112 is used to obtain input sample data and a selected application, and further store a binding relationship between the sample data and the selected application.

In one embodiment, as shown in FIG. 7, the apparatus further includes a matching module 114. The matching module 114 is used to obtain focus object, and obtain a focused application corresponding to the focus object; and further obtain sample data of the focused application. In addition, the matching module 114 is used to determine whether the input data matches with the sample data of the focused application; and display the privacy contents of the focused application. If the input data matches with the sample data of the focused application, then privacy content of the focused application is displayed.

In one embodiment, the system input event is selected from the group consisting of a (UI) sliding gesture input event, a voice input event, a key trigger event and an event triggered by an acceleration sensor.

Overall, the above method and apparatus for visiting privacy content is used to reduce user operating steps and improved operating efficiency, by obtaining system input event, and further obtaining the corresponding application by matching it with the input data extracted from the system input event. In this case, the user can access to the privacy content, free of accessing to the corresponding application.

It should be appreciated by those skilled in the art that all or part of the steps of the method described in the embodiments above may be executed by relevant hardware instructed by a program that may be stored in a computer-readable memory medium. The readable memory medium may be, for example, a read-only memory (ROM), a random access memory (RAM), a magnetic disk or a compact disc.

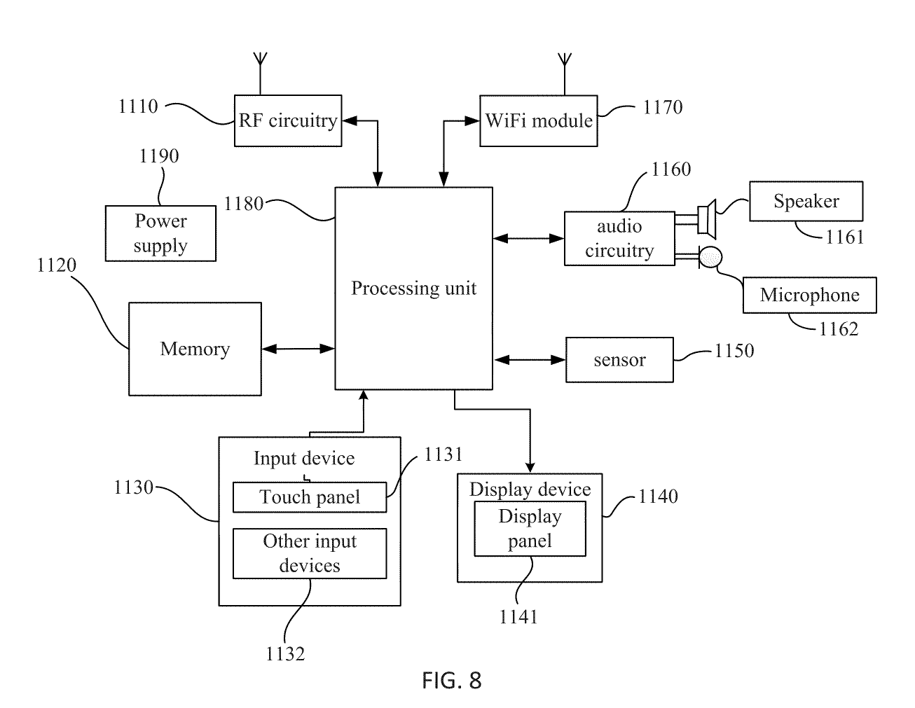

FIG. 8 illustrates an apparatus for visiting privacy content, according to another embodiment of the disclosure. The apparatus can be any portable electronic device, including but not limited to a mobile phone, a tablet computer, a personal digital assistant (PDA), a point of Sale (POS), a car PC, or the like, including a combination of two or more of these items. In this embodiment, the apparatus is a mobile phone.

In particular, FIG. 8 illustrates parts of the apparatus (mobile phone) in this embodiment. The mobile phone includes a RF circuitry 1110, a memory 1120, an input device 1130, a display device 1140, a sensor 1150, an audio circuitry 1160, a communication module, such as a wireless fidelity (WiFi) module 1170, a processing unit (CPU) 1180, and a power supply 1190, and other components, or the like, including a combination of two or more of these items.

Each of the components of the mobile phone will be introduced in details as follow.

The RF (radio frequency) circuitry 1110 is used to receive and send electromagnetic waves during a call or message handing. The RF circuitry 1110 converts electrical signals to/from electromagnetic waves and communicates with communications networks and other communications devices via the electromagnetic waves. The RF circuitry 1110 may include well-known circuitry for performing these functions, including but not limited to an antenna system, one or more amplifiers, an RF transceiver, a coupler, a Low Noise Amplifier (LNA), a duplexer, etc. The RF circuitry 1110 may communicate with other electronic devices via networks, such as the internet or wireless. The wireless communication may use any of a plurality of communications standards, protocols and technologies, including but not limited to Global System for Mobile communications (GSM), General Packet Radio Service (GPRS), code division multiple access (CDMA), wideband code division multiple access (W-CDMA), Long Term Evolution (LTE), a protocol for email, instant messaging, and/or Short Message Services (SMS)), or any other suitable communication protocol, including communication protocols not yet developed as of the filling date of this document.

The memory 1120 is used to store software programs and applications. In this embodiment, the CPU 1180 run various software programs and/or sets of instructions stored in the memory 1120 to perform various functions for the mobile phone and to process data. The memory 1120 may include a program section and a data storage section for storing data, wherein the storage section can be used to store operating system program, at least one application (such as sound playback, image playback, etc.) for a certain required function. The data storage section can be used to store data created by the mobile phone during operation (such as audio data, phone book, etc.). In addition, the memory 1120 may include high speed random access memory and may also include non-volatile memory, such as one or more magnetic disk storage devices, flash memory devices, or other non-volatile solid state memory devices.

The input device 1130 can be used to receive input number or character information, and generate key signal input in relation to user settings and functional control of the mobile phone. In one example, the input device 1130 includes a touch panel 1131 and other input devices 1132. The touch panel 1131 is also called touch screen, and forms a touch-sensitive surface that accepts user input (for example, users use a finger, a stylus, and any other suitable object or attachment on or near the touch panel 1131). In addition, the touch panel 1131 drives a connecting device according to pre-set drivers. The touch screen 1131 may include a touch-sensitive device and a touch screen controller. In operation, the touch-sensitive device detects contact (and any movement or break of the contact) on its surface. In an exemplary embodiment, a point of contact between the touch screen 1131 and the user corresponds to one or more digits of the user. The touch-sensitive device detects the contact and sends a corresponding signal to the touch screen controller. The touch screen controller receives the signal and converts the detected contact into contact coordinates, and further sends the coordinates to the CPU 1180. Besides, the touch screen controller receives and executes instructions from the CPU 1180. In this embodiment, the touch screen 1131 may detect contact and any movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 1131. In addition, the input device 1130 may include other input devices 1132. For example, the other input devices 1132 include but not limited to one or any of the combination of a physical keyboard, function keys (such as volume control keys, switches keys, etc.), a trackball, a mouse, an operating lever.

The display device 1140 is used to displays visual output to the user. The visual output may include input information of the user, or information provided to the user, or different kinds of menu of the mobile phone. The display device 1140 includes a display panel 1141, the display panel 1141 may use LCD (liquid crystal display) technology, or OLED (Organic Light-Emitting Diode) technology, although other display technologies may be used in other embodiments. In addition, the touch panel 1131 may cover the display panel 1141. When the touch panel 1131 detects contacts on or near its surface and sends a corresponding signal to the processor 1180 to determine the type of touch event, the processor 1180 controls the display panel 1141 to provide appropriate visual output according to different types of contacts. Although the touch panel 1131 and the display panel 1141 may be separated from each other to implement input and output function of the mobile phone, however, the touch panel 1131 and the display panel 1141 may be integrated together to implement input and output functions of the mobile phone.

The mobile phone may further include at least one sensor 1150, such as a light sensor, a motion sensor and other sensors. Specifically, the optical sensor may include an ambient light sensor and a proximity sensor, wherein the ambient light sensor can be used to adjust brightness of the display panel 1141 according to the brightness of ambient light. The proximity sensor can be used to close the display panel 1141 and/or backlighting, when the mobile phone is operated near to the ear. The accelerometer sensor is one example of the motion sensor. In particular, the accelerometer sensor may detect acceleration of each direction (typically three axes). When the mobile phone is keep static, magnitude and direction of gravity can be detected by the accelerometer sensor. Thus the accelerometer sensor can be used to identify posture of the mobile phone (such as horizontal and vertical screen switch, related games, magnetometer calibration posture), vibration recognition related functions (e.g., pedometer, percussion), etc.; Furthermore, a gyroscope, a barometer, a hygrometer, a thermometer, or an infrared sensor, or other sensors can also be configured in the mobile phone, further details of such sensors will not be described here.

The audio circuitry 1160, the speaker 1161, and the microphone 1162 provide an audio interface between a user and the mobile phone. The audio circuitry 1160 receives audio data and converts the audio data to an electrical signal, and transmits the electrical signal to the speaker 1161. The speaker 1161 converts the electrical signal to human-audible sound waves. In addition, the audio circuitry 1160 also receives electrical signals converted by the microphone 1162 from sound waves. The audio circuitry 1160 converts the electrical signal to audio data and transmits the audio data to the CPU 1180 for processing. The audio data may be transmitted to another mobile phone via the RF circuitry 1110, or transmitted to the memory 1120 for further processing.

WiFi is a short-range wireless technology. The mobile phone can help users to send and receive email, browse web service and access to streaming media etc. via a WiFi module 1170. In this embodiment, the WiFi module 1170 provides users with wireless broadband Internet accessing service. Although FIG. 8 shows a WiFi module 1170, it is noted that the WiFi module 1170 is only part of the mobile phone, that is, the WiFi module 1170 can be omitted in other embodiments without departing from the spirit of the present disclosure.

The processing unit 1180 is center of the mobile phone, and is used to connect all parts of the mobile phone using a variety of interfaces and connections. In this embodiment, the processing unit 1180 runs various software programs and/or sets of instructions stored in the memory 1120 to perform various functions for the mobile phone and to process data. Generally, the processing unit 1180 may include one or more processing units. Preferably, the processing unit 1180 may integrate an application processor and a modem processor, wherein the application processor is used mainly for processing operating system, user interface and applications, etc., and the modem processor is used mainly for wireless communications. It is noted, in other embodiments, the modem processor may not be integrated into the processing unit 1180.

The mobile phone may further include a power supply 1190 (such as battery) for providing power to various components. Preferably, the power supply 1190 can be logically connected to the processing unit 1180 via a power management system, and thus achieve management of charging, discharging, saving power, and other functions.

Although it is not shown in FIG. 8, the mobile phone may further include a camera, a Bluetooth module, etc., which are not further described herein.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for visiting privacy content, comprising:
obtaining system input event, and extracting input data corresponding to the system input event;
obtaining sample data matching with the input data;
accessing to an application corresponding to the sample data; and
displaying privacy content of the application.

2. The method of claim 1, wherein before displaying privacy content of the application, the method comprises:
displaying a password input interface;
obtaining an input password from the password input interface; and
verifying the input password, and displaying privacy content of the application if verification of the input password is passed.

3. The method of claim 1, wherein the method further comprises:
obtaining an input sample data;
obtaining a selected application from an application list; and
storing a binding relationship between the sample data and the selected application.

4. The method of claim 1, wherein before extracting input data corresponding to the system input event, the method comprises:
obtaining sample data of the focused application;
determining whether the input data matches with the sample data of the focused application; and
displaying the privacy contents of the focused application, if the input data matches with the sample data of the focused application.

5. The method of claim 1, wherein the system input event is selected from the group consisting of a sliding gesture input event, a voice input event, a key trigger event and an event triggered by an acceleration sensor.

6. An apparatus for visiting privacy content, comprising:
event monitoring module, configured to obtain system input event, and extracting input data corresponding to the system input event;
sample obtaining module, configured to obtain sample data matching with the input data;
application positioning module, configured to access to an application corresponding to the sample data; and
content display module, configured to display privacy content of the application.

7. The apparatus of claim 6, wherein the apparatus further comprising identity verification module, configured to:
display a password input interface;
obtain an input password from the password input interface; and
verify the input password, and activate the content display module to display privacy content of the application if verification of the input password is passed.

8. The apparatus of claim 6, wherein the apparatus further comprising pre-set module, configured to:
obtain an input sample data;
obtain a selected application from an application list; and
store a binding relationship between the sample data and the selected application.

9. The apparatus of claim 6, wherein the apparatus further comprising matching module, configured to:
obtain focus object, and obtaining a focused application corresponding to the focus object;
obtain sample data of the focused application;
determine whether the input data matches with the sample data of the focused application; and
display the privacy contents of the focused application, if the input data matches with the sample data of the focused application.

10. The apparatus of claim 6, wherein the system input event is selected from the group consisting of a sliding gesture input event, a voice input event, a key trigger event and an event triggered by an acceleration sensor.

11. An apparatus for visiting privacy content, comprising:
memory;
one or more processors; and
one or more modules stored in the memory and configured to execute by the one or more processors, the one or more modules including instructions:
to obtain system input event, and to extract input data corresponding to the system input event;
to obtain sample data matching with the input data;
to access to an application corresponding to the sample data; and
to display privacy content of the application.

12. The apparatus of claim 11, wherein the one or more modules further comprises instructions:
to display a password input interface;
to obtain an input password from the password input interface; and
to verify the input password, and to activate the content display module to display privacy content of the application if verification of the input password is passed.

13. The apparatus of claim 11, wherein the one or more modules further comprises instructions:
to obtain an input sample data;
to obtain a selected application from an application list; and
to store a binding relationship between the sample data and the selected application.

14. The apparatus of claim 11, wherein the one or more modules further comprises instructions:
to obtain focus object, and to obtain a focused application corresponding to the focus object;
to obtain sample data of the focused application;
to determine whether the input data matches with the sample data of the focused application; and
to display the privacy contents of the focused application, if the input data matches with the sample data of the focused application.

15. The apparatus of claim 11, wherein the system input event is selected from the group consisting of a sliding gesture input event, a voice input event, a key trigger event and an event triggered by an acceleration sensor.
